(19) United States
(12) Patent Application Publication
(10) Pub. No.: US 2026/0321733 A1
(43) Pub. Date: Oct. 15, 2026

(54) ELECTRODE LAMINATE MODULE AND METHOD FOR MANUFACTURING ELECTRODE LAMINATE MODULE

(71) Applicant: TOYOTA JIDOSHA KABUSHIKI KAISHA, Toyota-shi (JP)

(72) Inventor: Seigo FUJISHIMA, Miyoshi-shi (JP)

(73) Assignee: TOYOTA JIDOSHA KABUSHIKI KAISHA, Toyota-shi (JP)

(21) Appl. No.: 19/461,080

(22) Filed: Jan. 27, 2026

(30) Foreign Application Priority Data
Apr. 10, 2025 (JP) 2025-064967

(51) Int. Cl. H01M 10/0585; H01M 4/02

(52) U.S. Cl. CPC H01M 10/0585; H01M 2004/029

(57) ABSTRACT

In an electrode laminate module of the present disclosure, a current collector layer includes an extension portion extending beyond a cathode active material layer and an anode active material layer. A plurality of bipolar electrode laminates, a plurality of separator layers, and a plurality of resin sealing members are repeatedly stacked in a peripheral edge of the electrode laminate module in order of the bipolar electrode laminate, the resin sealing member, the separator layer, and the resin sealing member. The current collector layers of all or part of the bipolar electrode laminates each include, at part of a peripheral edge, an exposed portion that is exposed from the resin sealing members.

### CROSS-REFERENCE TO RELATED APPLICATION

This application claims priority to Japanese Patent Application No. 2025-064967 filed on Apr. 10, 2025. The disclosure of the above-identified application, including the specification, drawings, and claims, is incorporated by reference herein in its entirety.

### BACKGROUND

### 1. Technical Field

The present disclosure relates to an electrode laminate module and a method for manufacturing an electrode laminate module.

### 2. Description of Related Art

An electrode laminate module is a battery in which a battery laminate including, for example, a cathode current collector layer, a cathode active material layer, an electrolyte layer, an anode active material layer, and an anode current collector layer in the stated order is housed in an outer container etc.

For example, Japanese Unexamined Patent Application Publication No. 2021-170499 (JP 2021-170499 A) discloses a power storage module including: an electrode laminate formed by stacking, via a separator, a plurality of bipolar electrode cells each including a cathode active material layer on one surface of a current collecting foil and an anode active material layer on the other surface; and a sealing portion that is provided to the electrode laminate to cover the side surfaces of the electrodes along the stacking direction and in which the peripheral edge of the current collecting foil is embedded. The outer surface of the sealing portion has an opening including: a first portion that has a thickness equal to or larger than the stacking pitch of the current collecting foils and is open at the outer surface of the sealing portion; and a second portion that extends at a thickness smaller than the stacking pitch of the current collecting foils and is open between the peripheral edges of the current collecting foils adjacent to each other in the stacking direction to expose part of the peripheral edge of one current collecting foil to the inside. The power storage module described in JP 2021-170499 A can reduce an increase in resistance of a voltage detection line.

For example, Japanese Unexamined Patent Application Publication No. 2021-170500 (JP 2021-170500 A) discloses a power storage module including: an electrode laminate formed by stacking, via a separator, a plurality of bipolar electrodes each including a cathode active material layer on one surface of a current collecting foil and an anode active material layer on the other surface; and a sealing portion that is provided to the electrode laminate to cover the side surfaces of the bipolar electrodes along the stacking direction and in which the peripheral edge of the current collecting foil and a tab protruding from the peripheral edge in the plane direction of the current collecting foil are embedded. The outer surface of the sealing portion along the stacking direction has an opening that exposes the tab of one current collecting foil to the inside of the outer surface. The thickness of the opening in the stacking direction is equal to or larger than the stacking pitch of the current collecting foils. A cutout is provided at least in the peripheral edge of another current collecting foil adjacent to the one current collecting foil in the stacking direction such that the peripheral edge of the other current collecting foil does not overlap the opening as viewed in the stacking direction. The power storage module described in JP 2021-170500 A can reduce an increase in resistance of a voltage detection line.

Japanese Unexamined Patent Application Publication No. 2024-057752 (JP 2024-057752 A) discloses a terminal alignment jig for aligning the tips of a plurality of terminals arranged in one direction in a secondary battery. The terminal alignment jig includes at least one alignment member. The alignment member includes at least two rod-shaped members that extend in the length direction. At least one of the rod-shaped members has a comb-tooth shape with a plurality of cutouts on its surface. The terminals arranged in the one direction are sandwiched between the rod-shaped members such that each of the terminals is fitted into each of the cutouts, thereby aligning the tips of the terminals. The terminal alignment jig described in JP 2024-057752 A can adjust the positions of the tips of the terminals and align them appropriately.

### SUMMARY

In a battery in which a plurality of electrode laminates is stacked to be connected in series and is sealed with a sealing member, to detect the voltage of a current collector of each electrode laminate from the outside of the battery, it is necessary to connect a terminal to the current collector of each electrode laminate and extend this terminal from the sealing member. Since the step of connecting the terminal to the current collector of each electrode laminate and extending this terminal from the sealing member requires time and effort, it has not been easy to manufacture the battery using such a terminal.

In view of the above, an object of the present disclosure is to provide an electrode laminate module in which a plurality of electrode laminates is stacked to be connected in series and is sealed with sealing members, in which the voltage of a current collector of each electrode laminate can be detected, and that can be manufactured easily.

The present disclosure achieves the above object by the following means.

### First Aspect

An electrode laminate module including a plurality of bipolar electrode laminates, a plurality of separator layers, and a plurality of resin sealing members, in which:
each of the bipolar electrode laminates includes a cathode active material layer, a current collector layer, and an anode active material layer in order of the cathode active material layer, the current collector layer, and the anode active material layer;
the current collector layer includes an extension portion extending beyond the cathode active material layer and the anode active material layer;
the bipolar electrode laminates, the separator layers, and the resin sealing members are repeatedly stacked in a peripheral edge of the electrode laminate module in order of the bipolar electrode laminate, the resin sealing member, the separator layer, and the resin sealing member, and the resin sealing members are welded to the extension portions of the current collector layers and peripheral edges of the separator layers to seal the cathode active material layers and the anode active material layers; and
the current collector layers of all or part of the bipolar electrode laminates each include, at part of a peripheral edge, an exposed portion that is exposed from the resin sealing members.

### Second Aspect

The electrode laminate module according to the first aspect, in which:
the electrode laminate module has a polygonal shape; and
a plurality of the exposed portions is disposed at the same corner of the electrode laminate module.

### Third Aspect

The electrode laminate module according to the first or second aspect, in which:
the electrode laminate module has a polygonal shape;
a plurality of the exposed portions is disposed on the same side of the electrode laminate module; and
positions of the exposed portions at least partially differ from each other as viewed in a stacking direction.

### Fourth Aspect

The electrode laminate module according to the second or third aspect, in which the polygonal shape is a quadrangular shape.

### Fifth Aspect

A method for manufacturing the electrode laminate module according to any one of the first to fourth aspects, the method including:
(a) providing the bipolar electrode laminates, the separator layers, and the resin sealing members;
(b) repeatedly stacking the bipolar electrode laminates, the separator layers, and the resin sealing members in peripheral edges of the bipolar electrode laminates in the order of the bipolar electrode laminate, the resin sealing member, the separator layer, and the resin sealing member; and
(c) thermally welding the extension portion to the resin sealing member, the peripheral edge of the separator layer to the resin sealing member, and/or the resin sealing members to each other by heating the extension portion by laser radiation through the resin sealing member in a stacking direction each time the resin sealing member is stacked in the stacking (b).

The electrode laminate module of the present disclosure is an electrode laminate module in which a plurality of bipolar electrode laminates is stacked to be connected in series and is sealed with sealing members, in which the voltage of a current collector of each electrode laminate can be detected, and that can be manufactured easily.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a schematic diagram illustrating one embodiment and Example 2 of the present disclosure;

FIG. 1B is a schematic diagram illustrating the one embodiment and Example 2 of the present disclosure;

FIG. 1C is a schematic diagram illustrating the one embodiment and Example 2 of the present disclosure;

FIG. 2A is a schematic diagram illustrating another embodiment of the present disclosure;

FIG. 2B is a schematic diagram illustrating the other embodiment of the present disclosure;

FIG. 2C is a schematic diagram illustrating the other embodiment of the present disclosure;

FIG. 3A is a schematic diagram illustrating another embodiment and Example 1 of the present disclosure;

FIG. 3B is a schematic diagram illustrating the other embodiment and Example 1 of the present disclosure; and

FIG. 3C is a schematic diagram illustrating the other embodiment and Example 1 of the present disclosure.

### DETAILED DESCRIPTION OF EMBODIMENTS

Hereinafter, embodiments of the present disclosure will be described in detail. The present disclosure is not limited to the following embodiments, and various modifications may be made without departing from the scope of the present disclosure. The same elements are denoted by the same signs throughout the drawings, and description thereof will not be repeated.

### Electrode Laminate Module

An electrode laminate module of the present disclosure is an electrode laminate module including a plurality of bipolar electrode laminates, a plurality of separator layers, and a plurality of resin sealing members.

Each of the bipolar electrode laminates includes a cathode active material layer, a current collector layer, and an anode active material layer in the stated order.

The current collector layer includes an extension portion extending beyond the cathode active material layer and the anode active material layer.

The bipolar electrode laminates, the separator layers, and the resin sealing members are repeatedly stacked in a peripheral edge of the electrode laminate module in order of the bipolar electrode laminate, the resin sealing member, the separator layer, and the resin sealing member. The resin sealing members are welded to the extension portions of the current collector layers and the peripheral edges of the separator layers to seal the cathode active material layers and the anode active material layers.

The current collector layers of all or part of the bipolar electrode laminates each include, at part of a peripheral edge, an exposed portion that is exposed from the resin sealing members.

The above electrode laminate module is an electrode laminate module in which the bipolar electrode laminates are stacked to be connected in series and are sealed with the sealing members, in which the voltage of the current collector of each electrode laminate can be detected, and that can be manufactured easily.

A related-art electrode laminate module may include a voltage detection terminal connected to the current collector layer of each electrode laminate to detect the voltage of the current collector of the electrode laminate. It is necessary that part of the voltage detection terminal be connected to part of the current collector layer and another part extend from the electrode laminate module.

The electrode laminate module of the present disclosure is the electrode laminate module including the bipolar electrode laminates, the separator layers, and the resin sealing members. Each of the bipolar electrode laminates includes the cathode active material layer, the current collector layer, and the anode active material layer in the stated order. The current collector layer includes the extension portion extending beyond the cathode active material layer and the anode active material layer. The bipolar electrode laminates, the separator layers, and the resin sealing members are repeatedly stacked in the peripheral edge of the electrode laminate module in the order of the bipolar electrode laminate, the resin sealing member, the separator layer, and the resin sealing member. The resin sealing members are welded to the extension portions of the current collector layers and the peripheral edges of the separator layers to seal the cathode active material layers and the anode active material layers. The current collector layers of all or part of the bipolar electrode laminates each include, at part of the peripheral edge, the exposed portion that is exposed from the resin sealing members.

Therefore, the electrode laminate module of the present disclosure does not require the step of connecting the voltage detection terminal to the current collector layer, thereby reducing the number of manufacturing steps. Thus, the electrode laminate module of the present disclosure can be manufactured easily.

Hitherto, when manufacturing an electrode laminate module, the peripheral edge of the electrode laminate module is sealed in such a manner that the electrode laminates and the resin sealing members are stacked in the peripheral edges of the electrode laminates, and the electrode laminates and the resin sealing members are heated from the sides of the electrode laminates. In the electrode laminate module in which the current collector layers include the exposed portions in at least part of the bipolar electrode laminates, the exposed portions inhibit heating of the resin sealing members. Therefore, it is difficult to manufacture, by the related-art method, the electrode laminate module in which the current collector layers include the exposed portions.

In the present disclosure, the shape of the electrode laminate module is not particularly limited, but may be a polygonal shape such as a triangular shape, a quadrangular shape, or a hexagonal shape. In the present disclosure, the shape of the electrode laminate module refers to the shape in the plane direction of the electrode laminate module.

### Bipolar Electrode Laminate

The bipolar electrode laminate of the present disclosure includes the cathode active material layer, the current collector layer, and the anode active material layer in the stated order. In the present disclosure, the bipolar electrode laminates, the separator layers, and the resin sealing members are repeatedly stacked in the peripheral edge of the electrode laminate module in the order of the bipolar electrode laminate, the resin sealing member, the separator layer, and the resin sealing member. The current collector layers of all or part of the bipolar electrode laminates each include, at part of the peripheral edge, the exposed portion that is exposed from the resin sealing members.

### Cathode Active Material Layer

The cathode active material layer of the present disclosure is included in the electrode laminate of the present disclosure.

The cathode active material layer of the present disclosure contains a cathode active material. The cathode active material layer of the present disclosure may further contain at least one of a dispersant, a conductive aid, a solid electrolyte, and a binder as necessary.

In the present disclosure, the thickness of the cathode active material layer is not particularly limited, but may be, for example, 0.1 μm or more, 1.0 μm or more, 3.0 μm or more, 5.0 μm or more, or 10.0 μm or more, and may be 1000.0 μm or less, 700.0 μm or less, 500.0 μm or less, 300.0 μm or less, or 100.0 μm or less.

In the present disclosure, the density of the cathode active material layer is not particularly limited, but may be 0.5 g/cm³ or more, 0.7 g/cm³ or more, 1.0 g/cm³ or more, 1.5 g/cm³ or more, or 2.0 g/cm³ or more, and may be 15.0 g/cm³ or less, 10.0 g/cm³ or less, 8.0 g/cm³ or less, 6.0 g/cm³ or less, 4.0 g/cm³ or less , or 3.0 g/cm³ or less.

In the present disclosure, the material of the cathode active material is not particularly limited. Examples of the cathode active material include, but are not limited to, lithium cobalt oxide (LiCoO₂), lithium nickel oxide (LiNiO₂), lithium manganese oxide (LiMn₂O₄), lithium nickel cobalt manganese oxide (NCM: LiCO_{1/3}Ni_{1/3}Mn_{1/3}O₂), lithium nickel cobalt aluminum oxide (LiNi_{0.8}(CoAl)_{0.2}O₂), and a hetero-element-substituted Li-Mn spinel having a composition represented by Li₁₊ₓMn_{2-x-y}M_{y}O₄ (where M is one or more metal elements selected from Al, Mg, Co, Fe, Ni, and Zn).

In the present disclosure, the form of the cathode active material is not particularly limited, but may be, for example, particulate. When the cathode active material is particulate, the particle size D₅₀ of the cathode active material may be, for example, 1.0 nm or more, 5.0 nm or more, or 10.0 nm or more, and may be 500.0 μm or less, 100.0 μm or less, 50.0 μm or less, or 30.0 μm or less. In the present disclosure, the particle size D₅₀ is defined as the particle size (median diameter) corresponding to 50% of the volume-based cumulative particle size distribution as determined by a laser diffraction and scattering method.

The content of the cathode active material in the cathode active material layer of the present disclosure is not particularly limited, but may be 1.0% by mass or more, 5.0% by mass or more, 10.0% by mass or more, 15.0% by mass or more, or 20.0% by mass or more, and may be 50.0% by mass or less, 45.0% by mass or less, 40.0% by mass or less, 35.0% by mass or less, or 30.0% by mass or less.

In the present disclosure, at least one of a dispersant, a conductive aid, a solid electrolyte, and a binder may be contained in the cathode active material layer.

In the present disclosure, the conductive aid optionally contained in the cathode active material layer may be any known conductive aid for secondary batteries. Specific examples of the conductive aid include carbon materials such as Ketjen black (KB), vapor-grown carbon fibers (VGCFs), acetylene black (AB), carbon nanotubes (CNTs), carbon nanofibers (CNFs), carbon black, coke, and graphite. The conductive aid may be a metal material that can withstand the environment in which the battery is used. The conductive aid may be one type used alone or two or more types used in combination. The conductive aid may be in various forms such as powder or fibers.

The content of the conductive aid in the cathode active material layer of the present disclosure is not particularly limited, but may be 0.1% by mass or more, 0.5% by mass or more, 1.0% by mass or more, 3.0% by mass or more, or 5.0% by mass or more, and may be 20.0% by mass or less, 15.0% by mass or less, 10.0% by mass or less, 8.0% by mass or less, or 5.0% by mass or less.

In the present disclosure, the solid electrolyte optionally contained in the cathode active material layer may be any known solid electrolyte for secondary batteries. Examples of the solid electrolyte include inorganic solid electrolytes such as a sulfide solid electrolyte, an oxide solid electrolyte, and a halide solid electrolyte, and organic polymer electrolytes such as a polymer electrolyte. The electrolyte is preferably a sulfide solid electrolyte or an oxide solid electrolyte particularly from the viewpoint of heat resistance. The solid electrolyte may be, for example, particulate. The solid electrolyte may be one type used alone or two or more types used in combination.

Examples of sulfide solid electrolytes include solid electrolytes containing a Li element, an X element (X is at least one of P, As, Sb, Si, Ge, Sn, B, Al, Ga, and In), and a S element. The sulfide solid electrolyte may further contain at least one of an O element and a halogen element. Examples of halogen elements include an F element, a Cl element, a Br element, and an I element. The sulfide solid electrolyte may be glass (amorphous) or glass ceramic. Examples of sulfide solid electrolytes include, but are not limited to, Li₂S-P₂S₅, LiI-Li₂S-P₂S₅, LiI-LiBr-Li₂S-P₂S₅, Li₂S-SiS₂, Li₂S-GeS₂,and Li₂S-P₂S₅-GeS₂.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, and Li₃₊ₓPO₄₋ₓNₓ (LiPON). The oxide solid electrolyte may be amorphous or crystalline.

Examples of halide solid electrolytes include, but are not limited to, NaBH₄, NaB₁₀H₁₀, NaCB₉H₁₀, NaCB₁₁H₁₂, and NaB₁₂Cl₁₂.

Examples of polymer electrolytes include, but are not limited to, polyethylene oxide (PEO), polypropylene oxide (PPO), and copolymers thereof.

The content of the solid electrolyte in the cathode active material layer of the present disclosure is not particularly limited, but may be 1.0% by mass or more, 5.0% by mass or more, 10.0% by mass or more, 13.0% by mass or more, or 15.0% by mass or more, and may be 30.0% by mass or less, 20.0% by mass or less, 15.0% by mass or less, or 10.0% by mass or less.

In the present disclosure, the binder optionally contained in the cathode active material layer may be any known binder that is used in secondary batteries. Examples of binders include styrene butadiene rubber (SBR), carboxymethyl cellulose (CMC), acrylonitrile butadiene rubber (ABR), butadiene rubber (BR), polyvinylidene fluoride (PVDF), and polytetrafluoroethylene (PTFE). The binder may be one type used alone or two or more types used in combination.

The content of the binder in the cathode active material layer of the present disclosure is not particularly limited, but may be 0.1% by mass or more, 0.5% by mass or more, 1.0% by mass or more, 3.0% by mass or more, or 5.0% by mass or more, and may be 20.0% by mass or less, 15.0% by mass or less, 10.0% by mass or less, 8.0% by mass or less, or 5.0% by mass or less.

### Current Collector Layer

The current collector layer of the present disclosure is included in the bipolar electrode laminate of the present disclosure, and the current collector layers of all or part of the bipolar electrode laminates each include, at part of the peripheral edge, the exposed portion that is exposed from the resin sealing members.

Examples of materials of the current collector layer include, but are not limited to, aluminum, aluminum alloys, and stainless steel.

The thickness of the current collector layer is not particularly limited, but may be 20 μm or more, 30 μm or more, or 40 μm or more, and may be 70 μm or less, 60 μm or less, or 50 μm or less.

### Exposed Portion

In the present disclosure, the current collector layers of all or part of the bipolar electrode laminates each include, at part of the peripheral edge, the exposed portion that is exposed from the resin sealing members. In the present disclosure, the voltage of the electrode laminate can be detected by the exposed portion of the current collector layer of the electrode laminate.

In the present disclosure, the current collector layers of all or part of the bipolar electrode laminates may each include the exposed portion. When the current collector layers of part of the bipolar electrode laminates each include the exposed portion, for example, the bipolar electrode laminates in which the current collector layers include the exposed portions and the bipolar electrode laminates in which the current collector layers do not include the exposed portions may be stacked alternately.

In the present disclosure, the position of the exposed portion is not particularly limited. When the electrode laminate module has a polygonal shape, a plurality of exposed portions may be disposed at the same corner of the electrode laminate module, or may be disposed on the same side of the electrode laminate module. When the exposed portions are disposed on the same side of the electrode laminate module, the positions of the exposed portions may overlap each other or at least partially differ from each other as viewed in the stacking direction, or none of the exposed portions may overlap each other.

When the exposed portions are disposed at the same corner or on the same side of the electrode laminate module, it is preferable because the voltage of each of the bipolar electrode laminates can be easily detected using a voltage detection member having a corresponding or complementary shape.

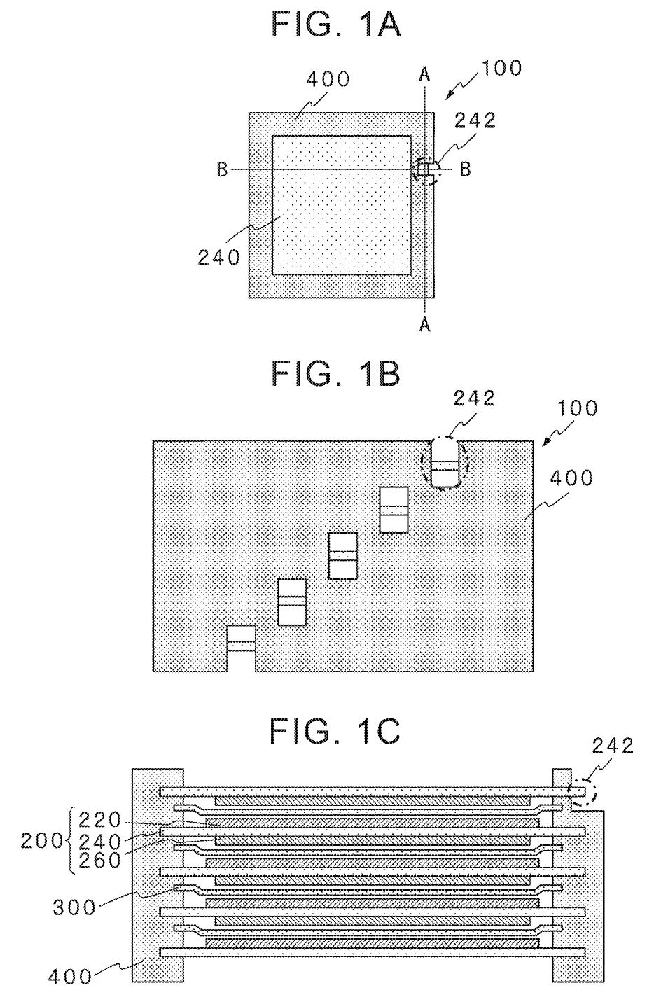

FIGS. 1A to 3C show the embodiments, but the present disclosure is not limited thereto. FIGS. 1A, 2A, and 3A are top views of electrode laminate modules of the embodiments. FIGS. 1B, 2B, and 3B are sectional views of the electrode laminate modules taken along line A in FIGS. 1A, 2A, and 3A, respectively. FIGS. 1C, 2C, and 3C are sectional views of the electrode laminate modules taken along line B in FIGS. 1A, 2A, and 3A, respectively. An electrode laminate module 100 shown in each of FIGS. 1A to 3C is formed by repeatedly stacking a plurality of bipolar electrode laminates 200, a plurality of separator layers 300, and a plurality of resin sealing members 400 in the peripheral edge of the electrode laminate module 100 in order of the bipolar electrode laminate 200, the resin sealing member 400, the separator layer 300, and the resin sealing member 400. Each of the bipolar electrode laminates 200 includes an anode active material layer 220, a current collector layer 240, and a cathode active material layer 260 in the stated order. At this time, part of the peripheral edge of the current collector layer 240 includes an exposed portion 242 that is exposed from an area sealed with the resin sealing member 400.

For example, as shown in FIGS. 1A, 1B, and 1C, the exposed portions 242 of the current collector layers 240 of the bipolar electrode laminates 200 may be disposed on the same side. In this case, the positions of the exposed portions 242 of the current collector layers 240 of the bipolar electrode laminates 200 may overlap each other as viewed in the stacking direction of the bipolar electrode laminates, or none of the exposed portions 242 may overlap each other as shown in FIGS. 1A, 1B, and 1C. When none of the exposed portions overlap each other or part of the exposed portions do not overlap each other as viewed in the stacking direction of the bipolar electrode laminates, the exposed portions of the current collector layers of the bipolar electrode laminates may be disposed, for example, in a stepped pattern as shown in FIGS. 1A, 1B, and 1C in the view of the side of the electrode laminate module including the exposed portions, or may be disposed at such positions that the pattern of the embodiment shown in FIGS. 1A, 1B, and 1C is repeated in a direction perpendicular to the stacking direction of the electrode laminates.

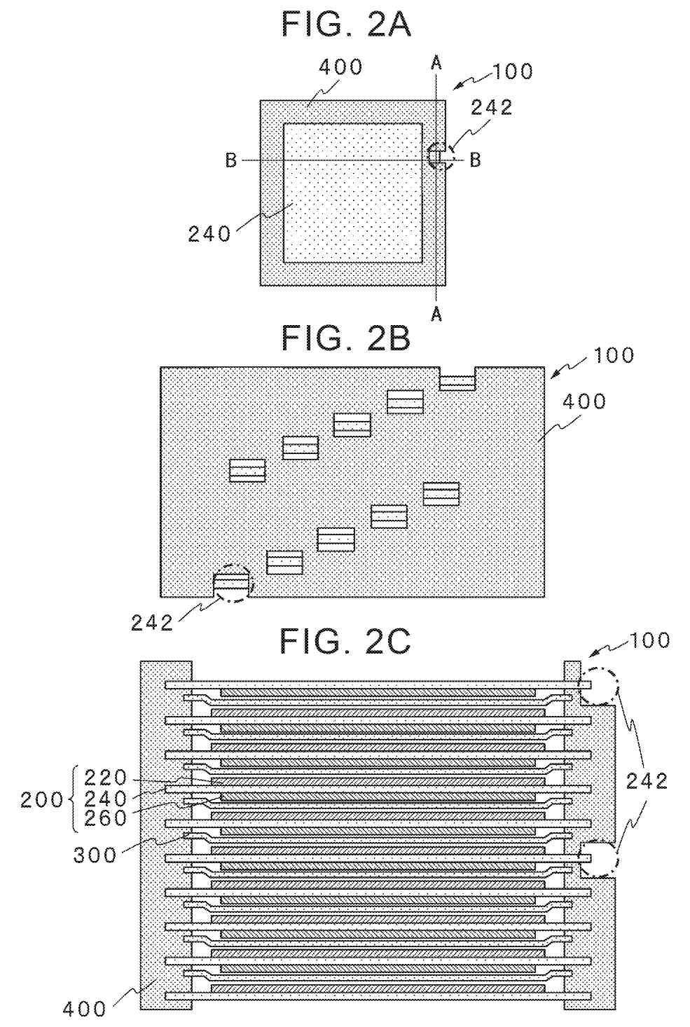

The electrode laminate module shown in FIGS. 2A, 2B, and 2C is an electrode laminate module in which the stacking pattern of the embodiment shown in FIGS. 1A, 1B, and 1C is repeated twice in the stacking direction. As shown in FIGS. 2A, 2B, and 2C, the positions of the exposed portions 242 of the current collector layers 240 of the bipolar electrode laminates 200 may at least partially overlap each other or at least partially differ from each other as viewed in the stacking direction. In this way, the stacking pattern of the embodiment shown in FIGS. 1A, 1B, and 1C may be repeated twice, three times, or more in the stacking direction. As shown in FIGS. 2A, 2B, and 2C, in the view of the side of the electrode laminate module including the exposed portions, the stepped patterns may be repeated in the stacking direction in a state in which the positions of all of the exposed portions constituting one stepped pattern are shifted in a direction perpendicular to the stacking direction of the bipolar electrode laminates from the positions of the exposed portions constituting the other stepped pattern. The stepped patterns may be repeated in the stacking direction in a state in which the positions of part of the exposed portions constituting one stepped pattern are shifted in the direction perpendicular to the stacking direction of the bipolar electrode laminates from the positions of the exposed portions constituting the other stepped pattern. The stepped patterns may be repeated in the stacking direction without shifting the positions.

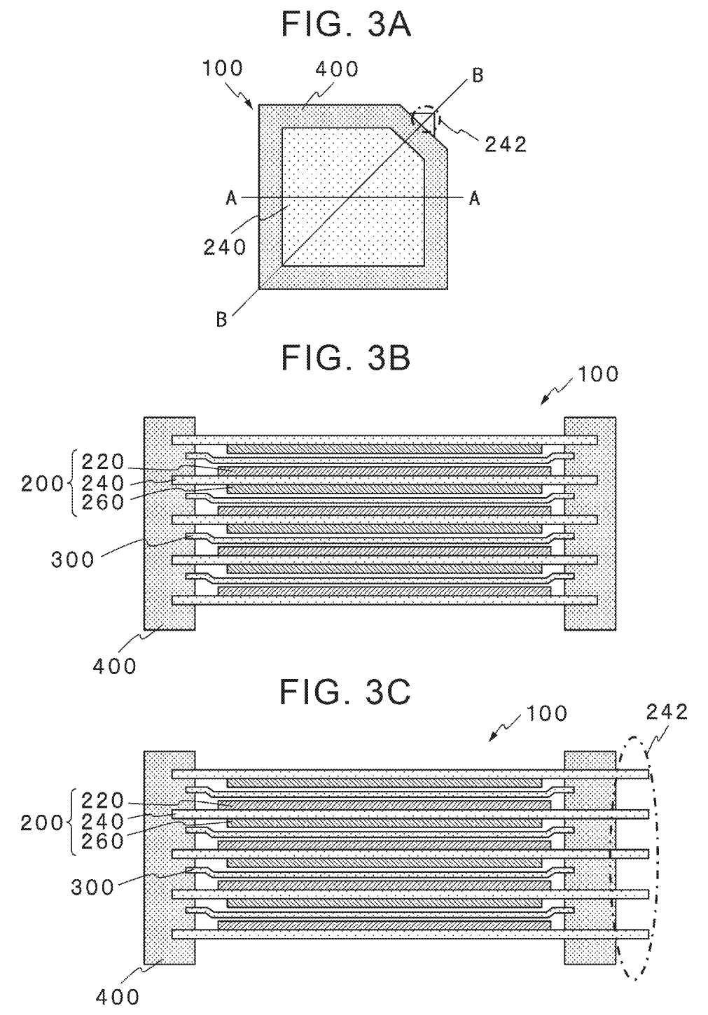

As shown in FIGS. 3A, 3B, and 3C, the exposed portions 242 of the current collector layers 240 of the bipolar electrode laminates 200 may be disposed at the same corner.

### Anode Active Material Layer

The anode active material layer of the present disclosure is included in the electrode laminate of the present disclosure.

The anode active material layer of the present disclosure contains an anode active material. The anode active material layer of the present disclosure may further contain at least one of a dispersant, a conductive aid, a solid electrolyte, and a binder as necessary.

In the present disclosure, the material of the anode active material is not particularly limited. The anode active material may be, for example, metallic lithium, or may be a material that can store and release metal ions such as lithium ions. Examples of materials that can store and release metal ions such as lithium ions include, but are not limited to, alloy-based anode active materials, carbon materials, lithium titanate (Li₄Ti₅O₁₂), and silicon carbide (SiC), that is, silicon particles.

The alloy-based anode active materials are not particularly limited, and examples thereof include Si-alloy-based anode active materials and Sn-alloy-based anode active materials. Examples of the Si-alloy-based anode active materials include silicon, silicon oxides, silicon carbides, silicon nitrides, and solid solutions thereof. The Si-alloy-based anode active material may contain metal elements other than silicon, such as iron (Fe), cobalt (Co), antimony (Sb), bismuth (Bi), lead (Pb), nickel (Ni), copper (Cu), zinc (Zn), germanium (Ge), indium (In), tin (Sn), and titanium (Ti). Examples of the Sn-alloy-based anode active materials include tin, tin oxides, tin nitrides, and solid solutions thereof. The Sn-alloy-based anode active material may contain metal elements other than tin, such as iron (Fe), cobalt (Co), antimony (Sb), bismuth (Bi), lead (Pb), nickel (Ni), copper (Cu), zinc (Zn), germanium (Ge), indium (In), tin (Sn), and titanium (Ti).

The carbon materials are not particularly limited, and examples thereof include hard carbon, soft carbon, and graphite.

For details of the anode active material, the dispersant, the conductive aid, the solid electrolyte, and the binder contained in the anode active material layer of the present disclosure, reference can be made to the above description regarding the cathode active material layer of the present disclosure.

### Resin Sealing Member

In the present disclosure, the resin sealing member is included in the electrode laminate module. In the present disclosure, the bipolar electrode laminates, the separator layers, and the resin sealing members are repeatedly stacked in the peripheral edge of the electrode laminate module in the order of the bipolar electrode laminate, the resin sealing member, the separator layer, and the resin sealing member. The resin sealing members are welded to the extension portions of the current collector layers and the peripheral edges of the separator layers to seal the cathode active material layers and the anode active material layers.

In the present disclosure, the resin sealing members may be welded to adjacent resin sealing members to form a single resin sealing member.

In the present disclosure, the material of the resin sealing member is not particularly limited, and can be freely selected within a range in which welding can be performed sufficiently between the current collector layer and the resin sealing member and between the resin sealing members. The resin sealing member can have a uniform thickness.

### Separator Layer

In the present disclosure, the separator layer is provided in the electrode laminate module. In the present disclosure, the bipolar electrode laminate, the resin sealing member, the separator layer, and the resin sealing member are repeatedly stacked in the peripheral edge of the electrode laminate module in the stated order. The resin sealing members are welded to the extension portions of the current collector layers and the peripheral edges of the separator layers.

In the present disclosure, the separator layer may be any separator layer commonly used in electrode laminate modules, and examples thereof include those made of resins such as butadiene rubber (BR), polyethylene (PE), polypropylene (PP), polyester, and polyamide. The separator layer may have a single-layer structure or a multi-layer structure. Examples of the separator layer having a multi-layer structure include a separator having a two-layer structure of PE/PP, and a separator having a three-layer structure of PP/PE/PP or PE/PP/PE. The separator layer may be made of a nonwoven fabric such as a cellulose nonwoven fabric, a resin nonwoven fabric, or a glass fiber nonwoven fabric.

In the present disclosure, the shape of the separator layer is not particularly limited, but may be the same shape as the shape of the electrode laminate module. In the present disclosure, the shape of the separator layer refers to the shape in the plane direction of the separator layer.

### Method for Manufacturing Electrode Laminate Module

The method of the present disclosure for manufacturing the electrode laminate module described in the present disclosure includes:
(a) providing the bipolar electrode laminates, the separator layers, and the resin sealing members;
(b) repeatedly stacking the bipolar electrode laminates, the separator layers, and the resin sealing members in the peripheral edges of the bipolar electrode laminates in the order of the bipolar electrode laminate, the resin sealing member, the separator layer, and the resin sealing member; and
(c) thermally welding the extension portion to the resin sealing member, the peripheral edge of the separator layer to the resin sealing member, and/or the resin sealing members to each other by heating the extension portion by laser radiation through the resin sealing member in the stacking direction each time the resin sealing member is stacked in step (b).

### Provision of Electrode Laminates (Step (a))

In the method of the present disclosure for manufacturing the electrode laminate module described in the present disclosure, the bipolar electrode laminates, the separator layers, and the resin sealing members are first provided.

For details of the bipolar electrode laminates, the separator layers, and the resin sealing members provided in the method of the present disclosure, reference can be made to the above description regarding the electrode laminate module of the present disclosure.

### Stacking Step (Step (b))

In the method of the present disclosure for manufacturing the electrode laminate module described in the present disclosure, the bipolar electrode laminates, the separator layers, and the resin sealing members are then repeatedly stacked in the peripheral edges of the bipolar electrode laminates in the order of the bipolar electrode laminate, the resin sealing member, the separator layer, and the resin sealing member.

For details of the bipolar electrode laminates, the separator layers, and the resin sealing members stacked in the method of the present disclosure, reference can be made to the above description regarding the electrode laminate module of the present disclosure.

### Thermal Welding (Step (c))

In the method of the present disclosure for manufacturing the electrode laminate module described in the present disclosure, the extension portion is thermally welded to the resin sealing member, the peripheral edge of the separator layer is thermally welded to the resin sealing member, and/or the resin sealing members are thermally welded to each other by heating the extension portion by laser radiation through the resin sealing member in the stacking direction each time the resin sealing member is stacked in step (b).

Thus, even when the current collector layer of the electrode laminate includes the exposed portion in the peripheral edge of the electrode laminate, welding can be performed sufficiently between the extension portion of the current collector layer and the resin sealing member, between the peripheral edge of the separator layer and the resin sealing member, and/or between the resin sealing members.

By repeating the method of the present disclosure, for example, repeating steps (b) and (c), the electrode laminate module in which the bipolar electrode laminates are stacked can be manufactured.

The present disclosure will be described in more detail below with reference to examples. However, these examples are not intended to limit the scope of the disclosure.

### Example 1

Bipolar electrode laminates each including a cathode active material layer, a current collector layer, and an anode active material layer in the stated order, separator layers, and resin sealing members were prepared. The cathode active material layer, the current collector layer, the anode active material layer, and the separator layer had a quadrangular shape in the plane direction, and the resin sealing member had a shape in the plane direction as shown in FIG. 3A.

The bipolar electrode laminates were stacked such that the cathode active material layer of one bipolar electrode laminate faced the anode active material layer of another bipolar electrode laminate, and the separator layer was disposed between the bipolar electrode laminates. In the peripheral edges of the current collector layers of the bipolar electrode laminates, the bipolar electrode laminate, the resin sealing member, the separator layer, and the resin sealing member were repeatedly stacked in the stated order. Each time the resin sealing member was stacked, a laser was radiated onto the resin sealing member in the stacking direction to weld the resin sealing member to the current collector layer, the peripheral edge of the separator layer to the resin sealing member, and the resin sealing members to each other. The stacking and welding were repeated to obtain an electrode laminate module according to Example 1. The electrode laminate module according to Example 1 had the shape shown in FIGS. 3A, 3B, and 3C.

### Example 2

An electrode laminate module according to Example 2 was obtained in the same manner as Example 1, except that the shape of the resin sealing member in the plane direction was the shape shown in FIG. 1A. The electrode laminate module according to Example 2 had the shape shown in FIGS. 1A, 1B, and 1C.

### Evaluation

In the electrode laminate modules according to Examples 1 and 2, it was confirmed that voltage detection members having shapes corresponding to the shapes of the exposed portions shown in FIGS. 3A, 3B, and 3C and FIGS. 1A, 1B, and 1C were attached to the exposed portions of the current collector layers to detect the voltages of the bipolar electrode laminates.

What is claimed is:

1. An electrode laminate module comprising a plurality of bipolar electrode laminates, a plurality of separator layers, and a plurality of resin sealing members, wherein:
each of the bipolar electrode laminates includes a cathode active material layer, a current collector layer, and an anode active material layer in order of the cathode active material layer, the current collector layer, and the anode active material layer;
the current collector layer includes an extension portion extending beyond the cathode active material layer and the anode active material layer;
the bipolar electrode laminates, the separator layers, and the resin sealing members are repeatedly stacked in a peripheral edge of the electrode laminate module in order of the bipolar electrode laminate, the resin sealing member, the separator layer, and the resin sealing member, and the resin sealing members are welded to the extension portions of the current collector layers and peripheral edges of the separator layers to seal the cathode active material layers and the anode active material layers; and
the current collector layers of all or part of the bipolar electrode laminates each include, at part of a peripheral edge, an exposed portion that is exposed from the resin sealing members.

2. The electrode laminate module according to claim 1, wherein:
the electrode laminate module has a polygonal shape; and
a plurality of the exposed portions is disposed at the same corner of the electrode laminate module.

3. The electrode laminate module according to claim 1, wherein:
the electrode laminate module has a polygonal shape;
a plurality of the exposed portions is disposed on the same side of the electrode laminate module; and
positions of the exposed portions at least partially differ from each other as viewed in a stacking direction.

4. The electrode laminate module according to claim 2, wherein the polygonal shape is a quadrangular shape.

5. The electrode laminate module according to claim 3, wherein the polygonal shape is a quadrangular shape.

6. A method for manufacturing the electrode laminate module according to claim 1, the method comprising:
(a) providing the bipolar electrode laminates, the separator layers, and the resin sealing members;
(b) repeatedly stacking the bipolar electrode laminates, the separator layers, and the resin sealing members in peripheral edges of the bipolar electrode laminates in the order of the bipolar electrode laminate, the resin sealing member, the separator layer, and the resin sealing member; and
(c) thermally welding the extension portion to the resin sealing member, the peripheral edge of the separator layer to the resin sealing member, and/or the resin sealing members to each other by heating the extension portion by laser radiation through the resin sealing member in a stacking direction each time the resin sealing member is stacked in the stacking (b).
